(19) United States
(12) Patent Application Publication
(10) Pub. No.: US 2007/0106737 A1
(43) Pub. Date: May 10, 2007

(54) System and process for delivery status notification

(76) Inventors: Thomas H. Barnes, Austin, TX (US); Dawn M. Canelones, Pflugerville, TX (US); Carol S. Walton, Austin, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/272,513

(22) Filed: Nov. 10, 2005

(51) Int. Cl. G06F 15/16

(52) U.S. Cl. 709/206

(57) ABSTRACT

The invention comprises a computer implemented system and process for delivery status notification of an electronic message, the system and process comprising: inserting into the electronic message a request for the delivery status notification; sending the electronic message to a recipient address; receiving a data packet having the delivery status; inserting the delivery status into the electronic message; and displaying a symbolic representation of the delivery status. In one embodiment of the present invention, the data packet is an administrative data packet having no substantive content. Additionally, an embodiment of the present invention may further comprise: receiving the electronic message; identifying a request for delivery status notification in the electronic message; identifying a return address in the electronic message; determining the delivery status of the electronic message; and sending an administrative data packet to the return address, the administrative data packet having the delivery status of the electronic message.

### FIELD OF THE INVENTION

The present invention is related to electrical computers and digital processing systems, and specifically to priority based messaging.

### BACKGROUND OF THE INVENTION

Currently, email clients such as LOTUS NOTES, MOZILLA THUNDERBIRD, and MICROSOFT OUTLOOK enable a user to exchange electronic messages with other users through networked email servers. Just as in the conventional postal system, a person that sends a message may want or need confirmation that the message is delivered successfully. Many contemporary email clients, including those listed above, provide some mechanism for requesting an electronic return receipt indicating successful delivery to a recipient. The receiving email server or the receiving mail client services the request by sending a second message back to the message originator.

Clearly, this conventional system for servicing electronic return receipts can significantly increase the burden on email systems. Thus, there is a need in the art for an improved system of servicing electronic return receipts that reduces the burden of conventional systems.

### SUMMARY OF THE INVENTION

The invention meeting the need identified above comprises a computer implemented system and process for delivery status notification of an electronic message, the system and process comprising: inserting into the electronic message a request for the delivery status notification; sending the electronic message to a recipient address; receiving a data packet having the delivery status; inserting the delivery status into the electronic message; and displaying a symbolic representation of the delivery status.

In one embodiment of the present invention, the data packet is an administrative data packet having no substantive content.

Additionally, an embodiment of the present invention may further comprise: receiving the electronic message; identifying a request for delivery status notification in the electronic message; identifying a return address in the electronic message; determining the delivery status of the electronic message; and sending an administrative data packet to the return address, the administrative data packet having the delivery status of the electronic message.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 illustrates an exemplary network of hardware devices in which the present invention can be practiced;

FIG. 2 is a schematic of a memory having components of the present invention stored therein;

FIG. 3 is a flowchart of an embodiment of the present invention integrated with a sender's messaging program; and

FIG. 4 is a flowchart of an embodiment of the present invention integrated with a recipient server or messaging program.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “electronic delivery notification” (EDN) program.

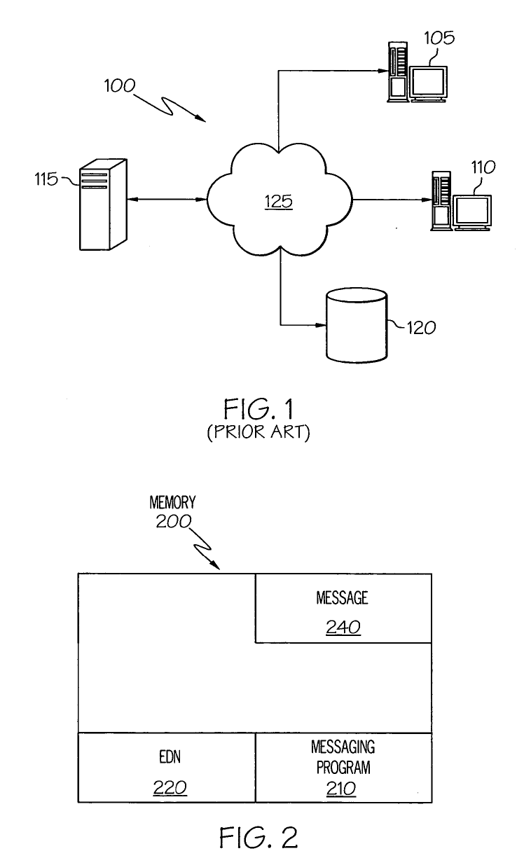

Additionally, the EDN program is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

EDN 220 typically is stored in a memory, represented schematically as memory 200 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 200. As depicted in FIG. 2, though, memory 200 may include additional data and programs. Of particular importance to EDN 220, memory 200 may include messaging program 210 and message 240.

Messaging program 210 represents any computer program that configures a computer to send and receive messages through a communications media, such as network connection 125. A person of skill in the art will appreciate that messaging program 210 may be embodied in any prior art electronic mail program loaded into the memory of a local computer, such as workstation computer 105. A person of skill in the art also will appreciate that the inventive functions of EDN 220 may be implemented as a stand-alone program, or be integrated into any prior art messaging program, such as messaging program 210.

The general data structure of message 240 is well known in the art and is not described in detail here. For purposes of this discussion, though, message 240 is assumed to comprise at least a message header and a message body. A message header includes data that represents properties of the respective message, such as the sender, subject, and date. A message body includes data that represents the substance of the communication. Message 240 may reside in a local memory, such as in workstation computer 105, or may reside in a centralized location, such as server computer 115 or persistent storage 120.

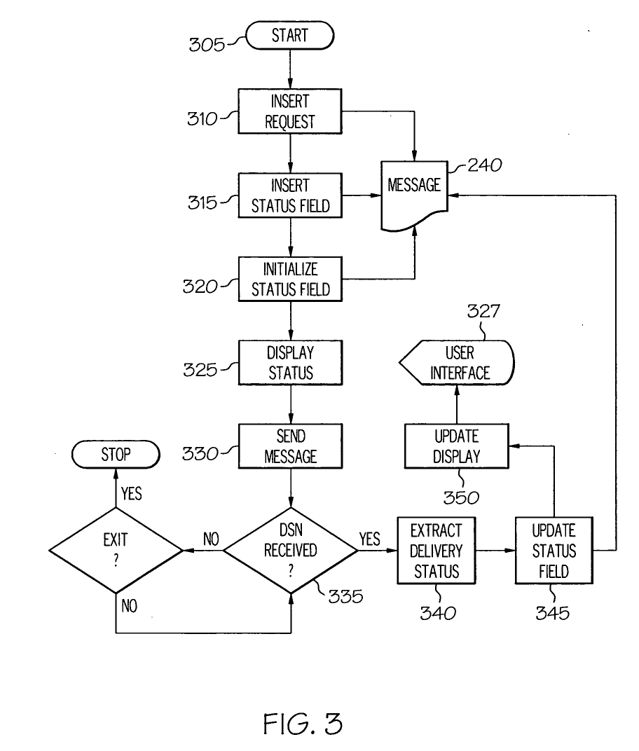

FIG. 3 illustrates the general operation of the present invention when integrated with messaging program 210. A message sender first composes a new message 240 destined for a recipient address, and requests a delivery status notification. The message sender's request for the delivery status notification activates EDN 220 (305). EDN 220 then inserts the request (310) and a status field (315) into message 240, preferably in the message header of message 240. Initially, EDN 220 sets the status field (320) to a value indicating that no delivery status notification has been returned. EDN 220 also displays the delivery status (325) symbolically in user interface 327 to messaging program 210. In a preferred embodiment, the delivery status is represented in a user interface as an icon, wherein a different icon is displayed for different delivery states. Messaging program 210 then sends message 240 over a network to a recipient address (330) specified by the message sender, retaining a copy of message 240 or of the message header of message 240. Messaging program 210 then monitors the network for messages and other data addressed to the message sender. If messaging program 210 receives a delivery status notification for message 240 (335), EDN 220 extracts the delivery status (340) and updates the status field (345) in message 240 to reflect the current delivery status, and updates the icon or other representation of the delivery status in the user interface (350).

Unlike conventional delivery status notification systems, however, EDN 220 enables messaging program 210 to receive notifications in an administrative data packet, as well as conventional return messages. An administrative data packet conforms to standard message transfer protocols and formats, except that it contains no substantive content (such as a message body). Accordingly, an administrative data packet generally is much smaller than a convention return message. Moreover, messaging program 210 does not create a new entry in a user's message list when it receives such an administrative data packet, thus conserving additional computing resources.

As just described, then, EDN 220 improves conventional notification systems by inserting a delivery status field into message headers and updating a representation of the delivery status field in a user interface as it receives delivery status notifications. To realize the full benefit of EDN 220, though, a message recipient's server or messaging program 210 also should be integrated with EDN 220 to enable notifications through administrative data packets.

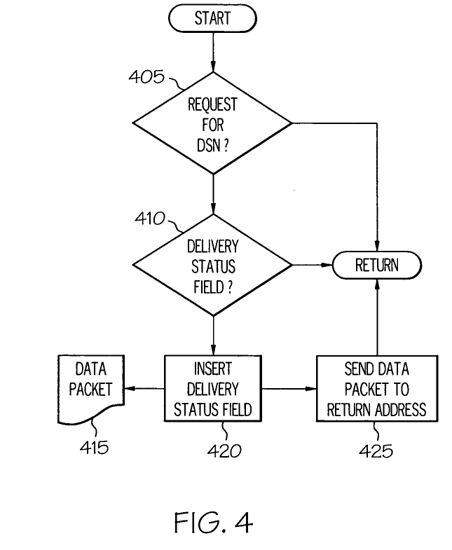

FIG. 4 illustrates the general operation of the present invention when integrated with a recipient's server or messaging program 210. Upon receiving message 240, EDN 220 determines if the message header includes a request for delivery status notification (405) and a delivery status field (410). If so, EDN 220 inserts into administrative data packet (415) a delivery status field (420) with an appropriate status value. EDN 220 then sends the administrative data packet to the return address (425) for processing as described above with reference to FIG. 3.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for delivery status notification of an electronic message, the process comprising:
inserting into the electronic message a request for the delivery status notification;
sending the electronic message to a recipient address;
receiving a data packet having the delivery status;
inserting the delivery status into the electronic message; and
displaying a symbolic representation of the delivery status.

2. The computer implemented process of claim 1 wherein the data packet is a second electronic message.

3. The computer implemented process of claim 1 wherein the data packet is an administrative data packet having no substantive content.

4. The computer implemented process of claim 1 wherein the symbolic representation is an icon in a user interface of a messaging program.

5. A computer implemented process for providing a delivery status of an electronic message, the process comprising:
receiving the electronic message;
identifying a request for delivery status notification in the electronic message;
identifying a return address in the electronic message;
determining the delivery status of the electronic message; and
sending an administrative data packet to the return address, the administrative data packet having the delivery status of the electronic message and no substantive content.

6. A machine for exchanging an electronic message and a delivery status notification thereof, the machine comprising:
a processor;
an output device connected to the processor;
a memory connected to the processor;
an electronic message stored in the memory;
a program in the memory operable to cause the processor to
insert into the electronic message a request for the delivery status notification;
send a copy of the electronic message to a recipient address;
receive a data packet having the delivery status;
insert the delivery status into the electronic message; and
display a representation of the delivery status on the output device.

7. The machine of claim 6 wherein the data packet is a second electronic message.

8. The machine of claim 6 wherein the data packet is an administrative data packet having no substantive content.

9. The machine of claim 6 wherein the symbolic representation is an icon in a user interface of the program.

10. The machine of claim 6 further comprising a second program in the memory operable to cause the processor to
receive the electronic message;
identify the request for delivery status notification in the electronic message;
identify a return address in the electronic message;
determine the delivery status of the electronic message; and
send the data packet to the return address, the data packet having the delivery status of the electronic message.

11. The machine of claim 10 wherein the data packet is a second electronic message.

12. The machine of claim 10 wherein the data packet is an administrative data packet having no substantive content.

13. The machine of claim 10 wherein the symbolic representation is an icon in a user interface of the program.

14. The machine of claim 6 further comprising:
a network medium coupled to the memory;
a second processor coupled to the memory; and
a second program in the memory operable to cause the second processor to
receive the electronic message over the network medium;
identify the request for delivery status notification in the electronic message;
identify a return address in the electronic message;
determine the delivery status of the electronic message; and
send the data packet to the return address, the data packet having the delivery status of the electronic message.

15. The machine of claim 14 wherein the data packet is a second electronic message.

16. The machine of claim 14 wherein the data packet is an administrative data packet having no substantive content.

17. The machine of claim 14 wherein the symbolic representation is an icon in a user interface of the program.
